(19) United States
(12) Patent Application Publication
(10) Pub. No.: US 2016/0127080 A1
(43) Pub. Date: May 5, 2016

(54) METHOD AND APPARATUS FOR CODING CHANNEL FOR NEAR FIELD HIGH SPEED LARGE CAPACITY WIRELESS COMMUNICATION

(71) Applicant: Electronics and Telecommunications Research Institute, Daejeon (KR)

(72) Inventors: Ik Jae CHUN, Daejeon (KR); Hoo Sung LEE, Sejong-si (KR); Moon-Sik LEE, Daejeon (KR)

(21) Appl. No.: 14/920,005

(22) Filed: Oct. 22, 2015

(30) Foreign Application Priority Data
Oct. 29, 2014 (KR) 10-2014-0148675

(51) Int. Cl. H04L 1/00; H04B 5/00

(52) U.S. Cl. CPC H04L 1/0041; H04B 5/0031; H04L 1/0057

(57) ABSTRACT

A method and apparatus for coding a channel in a near field wireless communication system are provided. The coding channel apparatus receives an input of data of a payload of an input frame, performs scrambling of the data, and encodes the scrambled data using an error correction code. The coding channel apparatus additionally encodes and outputs the encoded data using an additional channel code.

### CROSS-REFERENCE TO RELATED APPLICATION

This application claims priority to and the benefit of Korean Patent Application No. 10-2014-0148675 filed in the Korean Intellectual Property Office on Oct. 29, 2014, the entire contents of which are incorporated herein by reference.

### BACKGROUND OF THE INVENTION

(a) Field of the Invention

The present invention relates to a method and apparatus for coding a channel for near field high speed large capacity wireless communication.

(b) Description of the Related Art

Nowadays, with the development of a communication field, interest has increased in a short range wireless communication method. Particularly, interest has increased in Near Field Communication (NFC) technology, which is non-contact communication technology using a frequency band of 13.56 MHz as one of radio frequency identification (RFID) technologies.

Due to a short communication distance, relatively excellent security, and a cheap price, NFC technology has been in the spotlight as a next generation short range communication technology. Because NFC technology may use both data read and write functions, NFC technology does not require a reader (e.g., dongle) that has been conventionally required for using RFID. NFC technology is similar to existing short range communication technology such as Bluetooth, but provides convenience that does not require setting between devices like Bluetooth.

However, because NFC has a low transmission speed of about 400 kbps, NFC is appropriate for simple information transmission, but is inappropriate for transmission of high speed large capacity data. Further, near field wireless communication like existing NFC performs wireless power transmission and data transmission through a magnetic field, and NFC technology is technology that enables wireless communication between a reader and a tag while supplying power to a ‘non-powered tag’ having no power source itself. However, there is a drawback that NFC technology is inappropriate for high-rate data transmission and does not use a particular channel coding technology.

In order to solve a problem of near field wireless communication of such NFC, for high speed large capacity data transmission while having a merit of near field wireless communication, near field high speed communication (e.g., TransferJet, ecma-387) using microwaves has been introduced.

However, in near field high speed large capacity wireless communication that can secure security, as in near field wireless communication like NFC, a method of processing data for near field high speed communication is requested that can be implemented with a more simplified method and low power, compared with existing high speed communication (Bluetooth, WiFi).

### SUMMARY OF THE INVENTION

The present invention has been made in an effort to provide a method and apparatus for coding a channel having advantages of being capable of use in near field wireless communication.

The present invention has been made in an effort to further provide a method and apparatus for coding a channel having advantages of being capable of being implemented with low power and low cost in near field wireless communication.

An exemplary embodiment of the present invention provides a method of coding a channel in a near field wireless communication system including: receiving an input of data of a payload of an input frame and performing scrambling of the data; encoding the scrambled data using an error correction code; and additionally encoding the encoded data using an additional channel code.

The encoding of the scrambled data may include encoding the scrambled data using a Reed-Solomon (RS) code and outputting the encoded data to data including a parity byte.

The additionally encoding of the encoded data may include performing additional encoding using a binary Golay code as the additional channel code.

The additionally encoding of the encoded data may further include performing additional encoding using an extended binary Golay code in which a code rate is 12/24.

The performing of scrambling may include randomly forming and outputting an original code sequence by performing exclusive OR of the original code sequence of input data and a pseudo random signal.

Another embodiment of the present invention provides a channel coding apparatus in a near field wireless communication system including: a scrambler that receives an input of data of a payload of an input frame to perform scrambling of the data; an encoder that encodes the scrambled data using an error correction code; and an additional channel coding unit that additionally encodes the encoded data using an additional channel code.

The encoder may encode scrambled data using a Reed-Solomon (RS) code to output the encoded data to data including a parity byte.

The additional channel coding unit may perform additional encoding using a binary Golay code.

The additional channel coding unit may perform additional encoding using an extended binary Golay code in which a code rate is 12/24.

### BRIEF DESCRIPTION OF THE DRAWINGS

FIG. 1 is a block diagram illustrating a structure of a channel coding apparatus according to an exemplary embodiment of the present invention.

FIG. 2 is a diagram illustrating a process of processing data through a channel coding apparatus according to an exemplary embodiment of the present invention.

FIG. 3 is a diagram illustrating a process of generating a pseudo random signal in a scrambler according to an exemplary embodiment of the present invention.

FIG. 4 is a table illustrating a parameter of an extended binary Golay code that is used when coding an additional channel according to an exemplary embodiment of the present invention.

FIG. 5 is a flowchart illustrating a method of coding a channel according to an exemplary embodiment of the present invention.

FIG. 6 is a diagram illustrating a change of data that is processed using an extended binary Golay code as an additional channel code according to an exemplary embodiment of the present invention.

FIG. 7 is a graph illustrating a simulation result of a method of coding a channel according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in an entire specification, unless explicitly described to the contrary, the word “comprise” and variations such as “comprises” or “comprising” will be understood to imply the inclusion of stated elements but not the exclusion of any other elements.

Hereinafter, a method and apparatus for coding a channel for near field high speed large capacity wireless communication according to an exemplary embodiment of the present invention will be described.

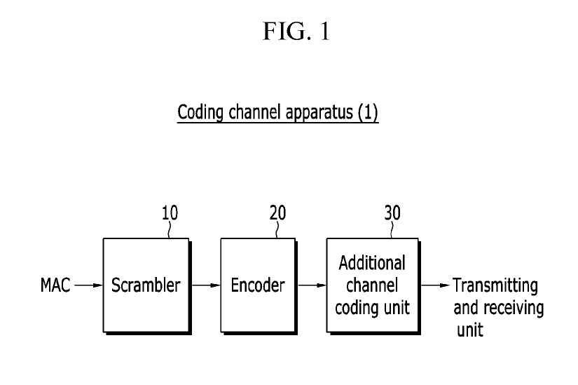

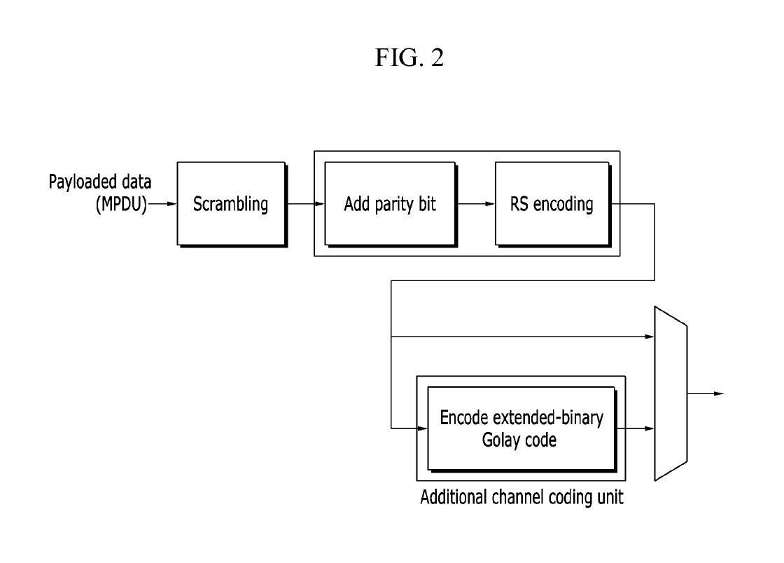

FIG. 1 is a block diagram illustrating a structure of a channel coding apparatus according to an exemplary embodiment of the present invention, and FIG. 2 is a diagram illustrating a process of processing data through a channel coding apparatus according to an exemplary embodiment of the present invention.

As shown in FIG. 1, a channel coding apparatus 1 according to an exemplary embodiment of the present invention includes a scrambler 10, an encoder 20, and an additional channel coding unit 30.

As shown in FIG. 2, the channel coding apparatus 1 according to an exemplary embodiment of the present invention performs channel coding of a payload of a frame that can be easily implemented while reducing an error rate of a packet in near field high speed large capacity wireless communication (e.g., near field communication within 10 cm using a radio frequency (RF)). In the channel coding apparatus 1, existing generally applied spreader and convolutional coding are not applied or another coding method that can be more easily implemented is applied.

By reconfiguring at least one MAC Service Data Unit (MSDU) that a MAC layer receives from a superordinate layer according to scheduling information of the MAC layer, at least one MPDU is generated. MPDUs that are generated in such a MAC layer are input to the channel coding apparatus 1.

The scrambler 10 performs scrambling of MPDUs, which are input data. Specifically, by performing exclusive OR of an original code sequence of an input MPDU and a pseudo random signal, the scrambler 10 randomly forms a code sequence to transmit. The scrambler 10 may use an additive scrambler, and the pseudo random signal may be generated using a Lear Feedback Shift Register (LFSR).

In the scrambler 10, a primitive polynomial of an LFSR for generating a pseudo random signal uses Equation 1 that generates an m-sequence.

g(D)=1+D⁵+D⁷+D¹⁰+D¹⁸ (Equation 1)

Here, D represents a single bit delay element.

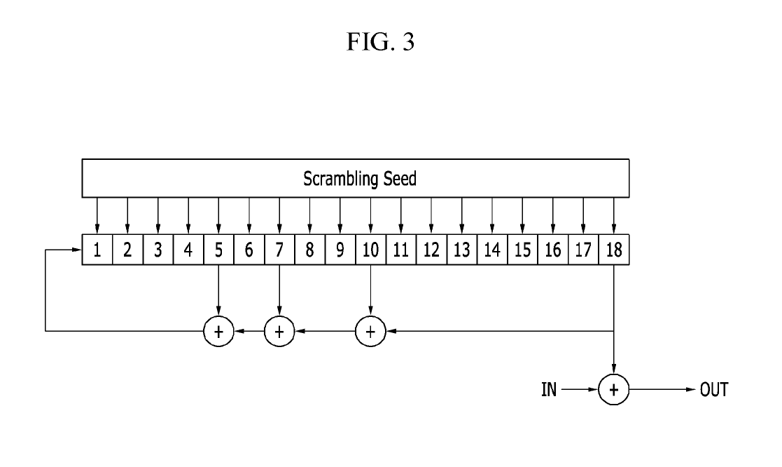

FIG. 3 is a diagram illustrating a process of generating a pseudo random signal in a scrambler according to an exemplary embodiment of the present invention.

As shown in FIG. 3, the scrambler 10 generates a pseudo random signal using a primitive polynomial g(D)=1+D⁵+D⁷+D¹⁰+D¹⁸ of Equation 1.

As described above, by performing exclusive OR of an original code sequence of an input MPDU and a pseudo random signal, the scrambler 10 scrambles and outputs a code sequence to transmit.

The encoder 20 encodes scrambled data, i.e., MPDU data. The encoder 20 may perform encoding using a Reed-Solomon (RS) code as an error correction code. Encoding using an RS code is a known block coding method that is used in a short range communication specification and a related communication specification and thus a detailed description thereof will be omitted. In order to correct an error of scrambled MPDU data, the encoder 20 performs encoding and outputs encoded data including a parity byte.

Specifically, the scrambled MPDU data is divided into a predetermined size of block, for example, a 224 byte block, and when one block is not 224 bytes, by adding 0-bits, the one block is processed into a 224 byte block. Parity bytes generated by the RS coding are added to the divided block data.

Each block of a predetermined size (224 bytes) is sequentially input to the encoder 20, and the encoder 20 generates 16 parity bytes using an RS code on each input block. Here, the encoder 20 uses a Galois field GF (2⁸) and an RS code of RSs 240 and 224 having a primitive polynomial p(X)=X⁸+X⁴+X³+X²+1. A generated primitive polynomial g(X) of the RS code may be represented by Equation 2.

$$g ( X ) = {\prod }_{i = 0}^{15} ( X - {a}^{i} ) \qquad ( Equation 2 )$$

Here, a primitive element is α=02^{tl}.

By applying the generated primitive polynomial to data that is processed into a block of a predetermined size to be input, the encoder 20 generates a parity byte (e.g., 16 bytes). The parity byte is used as an error correction code to be added to each data.

The additional channel coding unit 30 performs additional encoding of data that is output from the encoder 20 using an additional channel code. As an additional channel code, a convolutional code may be generally used, but in an exemplary embodiment of the present invention, in consideration of a design load in near field distance communication and latency of error correction, an extended-binary Golay code is used.

The additional channel coding unit 30 forms each bit of data including a parity byte that is output from the encoder 20 into a code using an extended binary Golay code and outputs code symbols.

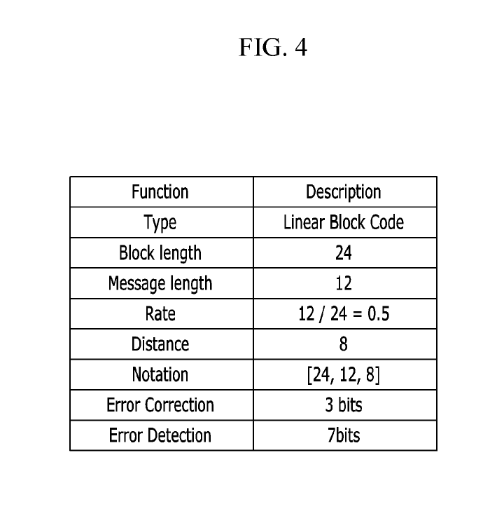

FIG. 4 is a table illustrating a parameter of an extended binary Golay code that is used when coding an additional channel according to an exemplary embodiment of the present invention.

When a binary Golay code is used as an additional channel code, by performing encoding of data that is output through an encoder, for example, data of 240 bytes, an extended binary Golay code in which a code rate that outputs 24 bits from 12 bit inputs is 12/24 may be used. The extended binary Golay code may be formed with parameters having a characteristic of FIG. 4. The extended binary Golay code provides an error correction ability of 3 bits and an error detection performance of 7 bits. By applying the extended binary Golay code, in near field distance communication, there is a merit that an additional channel coding unit 30 may be easily implemented with a smaller area, compared with a case of using an existing convolution code.

Such an additional channel coding unit 30 outputs code symbols in which each bit of data including a parity byte that is output from the encoder 20 is formed into an extended code using an extended binary Golay code. A payload including a code symbol that is generated in this way is transferred to a transmitting/receiving unit (may be referred to as an RF module), as shown in FIG. 1, and in this case, the payload may be transferred to the transmitting/receiving unit via a Serializer/Deserializer (SerDes). In order to improve error correction efficiency, the additional channel coding unit 30 may be selectively used, and for example, may be selected in consideration of a signal-to-noise ratio (SNR) of a received signal and a design load of an implementation circuit.

Hereinafter, a method of coding a channel according to an exemplary embodiment of the present invention based on a channel coding apparatus that is formed with such a structure will be described.

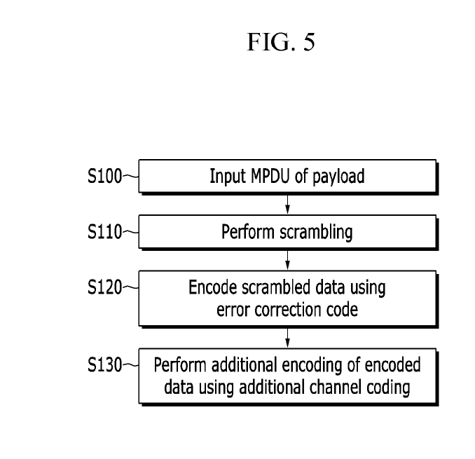

FIG. 5 is a flowchart illustrating a method of coding a channel according to an exemplary embodiment of the present invention.

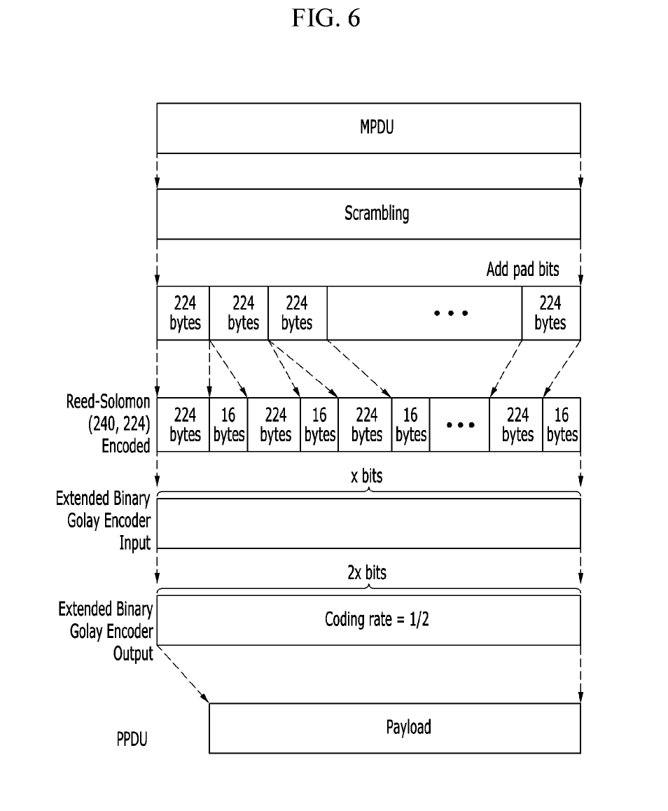

As shown in FIG. 6, the channel coding apparatus 1 receives an input of MPDUs from a MAC layer (S100) and performs scrambling of MPDUs, which are input data (S110). That is, by performing exclusive OR of an original code sequence of an input MPDU and a pseudo random signal, the channel coding apparatus 1 randomly forms and outputs a code sequence to transmit.

The channel coding apparatus 1 encodes scrambled data using an error correction code (S120). The channel coding apparatus 1 encodes scrambled data using a Reed-Solomon (RS) code and outputs scrambled data including a parity byte.

Therefore, the channel coding apparatus 1 performs additional channel coding of encoded data using an additional channel code (S130).

Specifically, by performing encoding using an extended binary Golay code as an additional channel code, the channel coding apparatus 1 forms each bit of data including an output parity byte in an extended code and outputs code symbols.

FIG. 6 is a diagram illustrating a change of data that is processed using an extended binary Golay code as an additional channel code according to an exemplary embodiment of the present invention, and particularly, illustrates a processing process of payload data using an extended binary Golay code by connecting to an RS code.

As described above, by additionally encoding encoded data using an additional channel code based on an error correction code, error correction efficiency can be improved.

Thereafter, the channel coding apparatus 1 outputs finally encoded and output data at S130 to the transmitting unit.

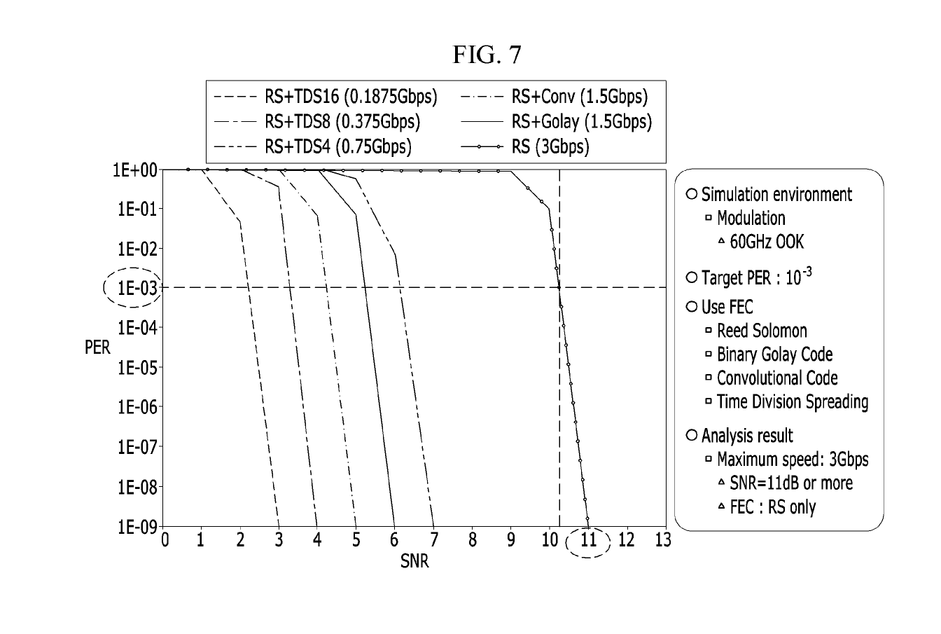

FIG. 7 is a graph illustrating a simulation result of a method of coding a channel according to an exemplary embodiment of the present invention.

Specifically, FIG. 7 represents a simulation result that compares a packet error rate (PER) according to an SNR in an additive white Gaussian noise (AWGN) environment of each case when applying only RS coding (RS), when applying time domain spreading (TDS) based on RS coding (RS+TDS16, RS+TDS8, and RS+TDS4), when applying convolutional coding based on RS coding (RS+Conv), and when applying extended binary Golay coding according to an exemplary embodiment of the present invention based on RS coding (RS+Golay). A data transmission performance in a PHY layer was represented based on 3 Gbps when applying only RS coding.

For 10⁻³ PER, a PER performance when applying an RS code and a convolution code through simulation of FIG. 7 may be better by approximately 1 dB than a PER performance when applying the RS code and the extended binary Golay code, but when designing a channel coding apparatus that can operate with low power while considering ease of implementation and fast performance, it can be seen that it is more advantageous to apply the RS code and the extended binary Golay code.

Therefore, in an exemplary embodiment of the present invention, as described above, channel coding is performed by connecting an RS code and an extended binary Golay code with a channel coding method of a low cost. By simplifying a modulation/demodulation method of frame data having a complex structure and much power consumption using existing wireless communication, simplified channel coding appropriate for near field high speed large capacity wireless communication in which low power is required at a near field distance within, for example, 10 cm is performed.

According to an exemplary embodiment of the present invention, for near field high speed large capacity wireless communication, a method and apparatus for coding a channel that can effectively code data are provided. Further, because channel coding of a high speed with low power can be performed, when implementing a non-contact near field communication apparatus, an implementation cost can be reduced.

The foregoing exemplary embodiment of the present invention may not only be embodied through an apparatus and a method, but may also be embodied through a program that executes a function corresponding to a configuration of the exemplary embodiment of the present invention or through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of coding a channel in a near field wireless communication system, the method comprising:
receiving an input of data of a payload of an input frame and performing scrambling of the data;
encoding the scrambled data using an error correction code; and
additionally encoding the encoded data using an additional channel code.

2. The method of claim 1, wherein the encoding of the scrambled data comprises encoding the scrambled data using a Reed-Solomon (RS) code and outputting the encoded data to data comprising a parity byte.

3. The method of claim 1, wherein the additional encoding of the encoded data comprises performing additional encoding using a binary Golay code as the additional channel code.

4. The method of claim 3, wherein the additionally encoding of the encoded data further comprises performing additional encoding using an extended binary Golay code in which a code rate is 12/24.

5. The method of claim 1, wherein the performing of scrambling comprises randomly forming and outputting an original code sequence by performing exclusive OR of the original code sequence of input data and a pseudo random signal.

6. A channel coding apparatus in a near field wireless communication system, the channel coding apparatus comprising:
a scrambler that receives an input of data of a payload of an input frame to perform scrambling of the data;
an encoder that encodes the scrambled data using an error correction code; and
an additional channel coding unit that additionally encodes the encoded data using an additional channel code.

7. The channel coding apparatus of claim 6, wherein the encoder encodes scrambled data using a Reed-Solomon (RS) code to output the encoded data to data comprising a parity byte.

8. The channel coding apparatus of claim 6, wherein the additional channel coding unit performs additional encoding using a binary Golay code.

9. The channel coding apparatus of claim 8, wherein the additional channel coding unit performs additional encoding using an extended binary Golay code in which a code rate is 12/24.
